(19) United States
(12) Patent Application Publication
(10) Pub. No.: US 2026/0052163 A1
(43) Pub. Date: Feb. 19, 2026

(54) Cybersecurity Device for Emulating Networked Devices in Industrial Systems

(71) Applicant: Daniel Scott Ward, Chester, NH (US)

(72) Inventor: Daniel Scott Ward, Chester, NH (US)

(21) Appl. No.: 18/805,592

(22) Filed: Aug. 15, 2024

(51) Int. Cl. H04L 9/40

(52) U.S. Cl. CPC H04L 63/1425; H04L 63/1491

(57) ABSTRACT

A cybersecurity device configured for integration into a networked system, comprising a housing for attachment to a mounting structure, one or more processors, input/output (I/O) interfaces, a network interface, and memory storing executable instructions. The device emulates a plurality of devices by replicating known parameters of corresponding real devices, interacts with a system using a communication protocol, and alters its network configuration settings, including MAC address, IP address, and open ports. The I/O interfaces are configured to receive and transmit signals, enabling the device to mimic various types of networked devices. The cybersecurity device is suitable for deployment in environments requiring enhanced network security, such as industrial control systems, by providing a realistic decoy that integrates seamlessly into existing networks.

### FIELD OF INVENTION

The present invention relates generally to the field of cybersecurity, specifically to devices designed for integration into industrial control systems to enhance network security.

### BACKGROUND

The development of cybersecurity measures tailored for industrial control systems (ICS) and supervisory control and data acquisition (SCADA) networks has become increasingly important as these systems have evolved and their vulnerabilities have been exposed. Traditionally, industrial networks were considered secure due to their isolation from external networks—a practice known as air-gapping. However, the gradual integration of these systems with broader enterprise networks, driven by the need for remote monitoring, data collection, and efficiency improvements, has opened them up to cyber threats. The increased connectivity has rendered these networks vulnerable to attacks that can have significant consequences, including physical damage to infrastructure and disruption of essential services.

Existing cybersecurity solutions for industrial networks have often been adapted from those used in traditional IT environments. These solutions, while effective to some degree, do not always address the unique requirements of industrial environments. For example, many traditional cybersecurity tools focus on protecting data and network integrity in dynamic environments with frequent updates and changes. In contrast, industrial systems are typically designed for stability and longevity, with updates and changes being less frequent. As a result, conventional IT-based security measures may not be fully effective in protecting industrial networks from sophisticated attacks.

One common approach in the cybersecurity landscape is the deployment of honeypots-decoy systems that mimic legitimate targets to lure attackers away from critical assets. Honeypots have been extensively used in IT environments to detect and analyze malicious activities. However, in industrial networks, the use of honeypots has been limited, largely due to the complexity of accurately simulating the behavior of industrial devices and processes. Many existing industrial honeypots are virtual or simulated environments that do not convincingly replicate the intricacies of a real SCADA system. Consequently, sophisticated attackers, who are often well-versed in the characteristics of industrial systems, may easily identify these decoys as fake, reducing their effectiveness.

Another limitation of current honeypot solutions is their lack of physical presence within the industrial environment. Most honeypots are software-based and reside on virtual machines or servers, making them distinct from the physical devices typically found in control systems. This discrepancy can be a giveaway to attackers who are familiar with the physical setup of industrial environments. The absence of a physical, hardware-based component that convincingly mimics real industrial devices limits the ability of these honeypots to deceive attackers and gather valuable intelligence.

Moreover, existing honeypot solutions do not typically integrate well with the specific hardware and communication protocols used in industrial networks. For example, devices from manufacturers like Rockwell Automation, Siemens, and Schneider Electric use proprietary communication protocols and hardware configurations that are not easily replicated by generic cybersecurity solutions. This lack of specificity can reduce the effectiveness of honeypots in industrial settings, as they may not convincingly mimic the devices and systems they are meant to protect.

The challenge, therefore, lies in creating a cybersecurity solution that not only mimics the appearance and behavior of industrial devices but also integrates convincingly into the physical and logical architecture of industrial networks. Such a solution would need to be versatile enough to adapt to the unique configurations of different industrial environments while being robust enough to withstand sophisticated attacks. The goal would be to create a decoy that is indistinguishable from real devices, both in terms of its network behavior and its physical presence within the control system.

It is within this context that the present invention is provided.

### SUMMARY

The present invention relates to a cybersecurity device configured for integration into a networked system. The device comprises a housing that is configured for attachment to a mounting structure, such as a DIN rail, allowing it to be physically integrated into various control environments. Within the housing, the device includes one or more processors, a plurality of input/output (I/O) interfaces, a network interface, and a memory. The I/O interfaces are configured to receive and transmit signals, while the network interface connects the device to a network.

The memory stores executable instructions that, when executed by the processors, cause the device to emulate a plurality of devices on the network. These emulated devices replicate the known parameters of corresponding real devices, allowing them to interact with a control system using a communication protocol. The device also has the capability to alter its network configuration settings, including the Media Access Control (MAC) address, Internet Protocol (IP) address, and open network ports, to further disguise itself on the network. Additionally, the device monitors network traffic, logs data related to the network communications, and transmits this data to an external server via a unidirectional data transmission channel.

In some embodiments, the cybersecurity device is configured for mounting on a DIN rail. This allows for easy integration into existing industrial control panels, facilitating deployment in environments where space and standardization are important considerations.

In further embodiments, the plurality of emulated devices includes industrial control devices such as sensors, actuators, and programmable logic controllers. This enables the cybersecurity device to convincingly mimic the operation of common industrial components.

In yet further embodiments, the industrial control devices are emulated based on known parameters of devices manufactured by well-known manufacturers such as for example Rockwell Automation, Siemens, or Schneider Electric. By replicating the specific characteristics of well-known manufacturers' devices, the cybersecurity device increases its likelihood of being perceived as genuine by intruders.

In further embodiments, the I/O interfaces of the cybersecurity device are configured to receive and transmit analog signals. This feature allows the device to replicate the behavior of analog-based sensors and actuators, which are commonly found in industrial systems.

In yet further embodiments, the I/O interfaces are configured to receive and transmit discrete signals. This capability enables the device to emulate the operation of binary or on/off devices, such as switches or discrete sensors, which are integral to many control processes.

In some embodiments, the memory of the cybersecurity device stores a database of known parameters for emulating the plurality of devices. This database is used by the processors to accurately replicate the characteristics of real devices.

In further embodiments, the alteration of network configuration settings by the cybersecurity device is performed dynamically. This dynamic alteration makes it more difficult for unauthorized users to track or predict the device's behavior.

In yet further embodiments, the cybersecurity device scans the network to identify available network configuration settings before altering them. This scanning ensures that the device does not create conflicts with existing networked devices.

In some embodiments, the network interface of the cybersecurity device is configured to create multiple virtual network interfaces, each with distinct network configuration settings. This allows the device to simulate the presence of multiple devices on the network.

In further embodiments, the logged data related to the network communications includes details such as source and destination addresses, communication timestamps, protocols used, and the content of the communications.

In yet further embodiments, the external server to which the logged data is transmitted is configured to perform threat analysis. By analyzing the transmitted data, the server can identify potential security breaches and respond appropriately.

In some embodiments, the unidirectional data transmission channel comprises a data diode. This ensures that the data can only flow outwards from the device, preventing any possibility of external tampering or data corruption.

In further embodiments, the housing of the cybersecurity device includes environmental protection features such as dust resistance, water resistance, and vibration damping.

In yet further embodiments, the processors of the cybersecurity device execute self-diagnostic routines to monitor the operational status of the device. These diagnostics can detect issues such as hardware faults or environmental conditions that may affect the device's performance.

In some embodiments, the cybersecurity device is configured to generate physical alarm outputs via the I/O interfaces in response to detected network threats or anomalies. This allows for immediate notification of potential security issues within the physical environment.

In further embodiments, the housing of the cybersecurity device includes indicators, such as LEDs, that provide visual feedback on the operational status of the device.

### BRIEF DESCRIPTION OF THE DRAWINGS

Various embodiments of the invention are disclosed in the following detailed description and accompanying drawings.

FIG. 1 illustrates an example cybersecurity decoy system integrated into an industrial control network with various simulated devices and network components.

FIG. 2 illustrates an example computer-implemented method where a hacker infiltrates the SCADA control system and alters device parameters, triggering an alarm.

FIG. 3 illustrates an example isometric perspective view of the device housing mounted to a DIN rail within an industrial control environment.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The term “cybersecurity device” refers to any device having a physical hardware component designed to protect networked systems by emulating real devices and monitoring network traffic. This includes, but is not limited to, devices integrated into industrial control systems, enterprise networks, or any system where network security is a priority. In one example implementation, the cybersecurity device may be a physical unit mounted on a DIN rail within a control panel, equipped with a processor, memory, and network interfaces, and capable of emulating devices like sensors and actuators to deceive potential intruders.

The term “networked system” refers to any system in which multiple devices or components are connected via a communication network, enabling data exchange and interaction among them. This includes, but is not limited to, industrial control systems, SCADA systems, enterprise networks, and IoT ecosystems. In one example implementation, the networked system may be an industrial network comprising programmable logic controllers (PLCs), human-machine interfaces (HMIs), and sensors communicating over Ethernet using the Modbus TCP protocol.

The term “emulate” refers to the process by which the cybersecurity device replicates the behavior and communication patterns of real devices within a network. This includes, but is not limited to, simulating the data output, response timings, and communication protocols of devices from manufacturers such as Rockwell Automation, Siemens, or Schneider Electric. In one example implementation, the cybersecurity device emulates a Siemens temperature sensor by generating temperature readings within a predefined range and responding to Modbus queries in a manner consistent with a real Siemens device.

The term “network interface” refers to any hardware or software component that allows the cybersecurity device to connect to and communicate over a network. This includes, but is not limited to, wired interfaces such as Ethernet ports, wireless interfaces such as Wi-Fi modules, and virtual interfaces configured by the device's software. In one example implementation, the network interface may be an Ethernet port configured to connect the cybersecurity device to a local area network (LAN) in an industrial control environment.

The term “communication protocol” refers to any set of rules or standards that govern the data exchange between the cybersecurity device and other networked components. This includes, but is not limited to, industrial communication protocols such as Modbus, Profibus, and OPC UA, as well as standard networking protocols like TCP/IP. In one example implementation, the communication protocol used by the cybersecurity device may be Modbus TCP, enabling it to exchange data with PLCs and SCADA systems in a manner consistent with standard industrial practices.

The term “unidirectional data transmission channel” refers to any communication link that allows data to flow in only one direction, ensuring that information can be sent from the cybersecurity device to an external server without the possibility of data being sent back to the device. This includes, but is not limited to, physical data diodes and software-enforced unidirectional communication protocols. In one example implementation, the unidirectional data transmission channel may be a data diode that transmits logged network data from the cybersecurity device to a remote analysis server.

The cybersecurity device may support various wireless communication standards to provide flexibility in network integration. This includes, but is not limited to, Wi-Fi (IEEE 802.11), Bluetooth, Zigbee, and LoRa. In one example implementation, the device may be equipped with a Wi-Fi module conforming to the IEEE 802.11ac standard, allowing it to connect wirelessly to a network, thereby providing ease of installation in environments where wired connections are impractical.

### DESCRIPTION OF DRAWINGS

The present invention relates to a cybersecurity device designed for integration into networked systems, including but not limited to industrial control systems, SCADA systems, and other environments where the protection of critical infrastructure is paramount. The invention addresses several shortcomings identified in the prior art by providing a hardware-based solution that physically integrates into existing control panels and networks, offering a more realistic and robust decoy compared to purely virtual or software-based honeypots.

Traditional cybersecurity solutions in industrial environments often rely on virtual honeypots or simulated environments that fail to convincingly replicate the behavior of actual industrial devices. These solutions are typically confined to software running on virtual machines or servers, making them easily distinguishable from real industrial equipment. As a result, sophisticated attackers may quickly identify these honeypots as decoys, reducing their effectiveness in preventing unauthorized access or mitigating cyber threats.

The present invention overcomes these limitations by offering a physical device that can be mounted directly onto a DIN rail within an industrial control panel, making it indistinguishable from other legitimate devices. This device is capable of emulating a wide range of networked devices, including sensors, actuators, and programmable logic controllers (PLCs), by replicating the known parameters and communication protocols of real equipment from well-known manufacturers. By integrating into the physical and logical architecture of the network, the device creates a more convincing decoy that is difficult for attackers to detect or bypass.

One of the advantages of the present invention is its ability to dynamically alter its network configuration settings, such as MAC addresses, IP addresses, and open ports, to present a moving target for potential intruders. This behavior further complicates an attacker's efforts to identify and exploit the device, increasing the time and effort required to launch a successful attack. Additionally, the device monitors network traffic, logs detailed data on interactions with the emulated devices, and transmits this information securely to an external server via a unidirectional data transmission channel, providing valuable insights for threat analysis and network defense.

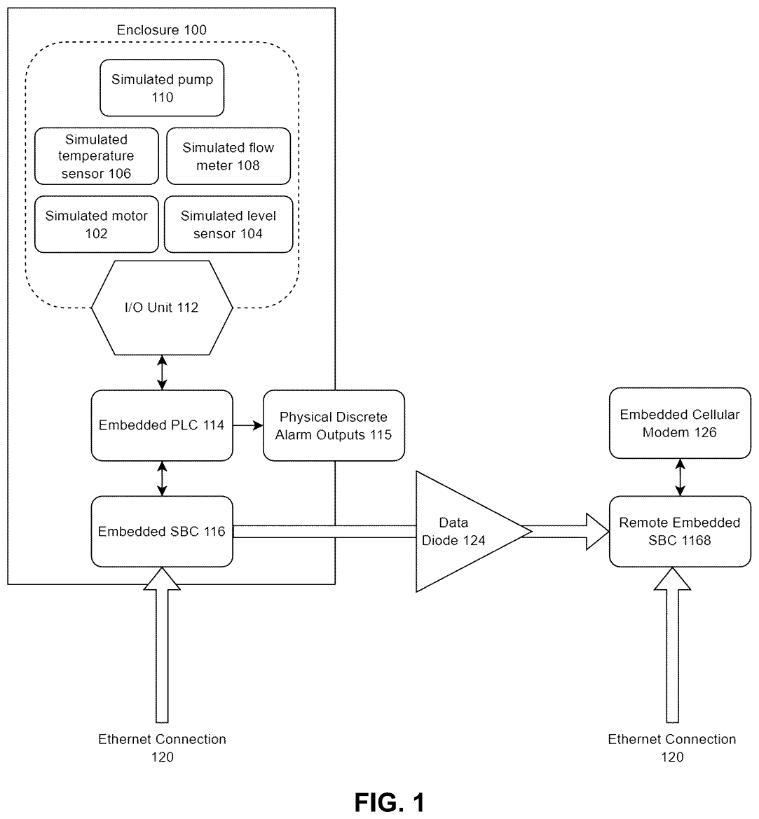

Referring now to the drawings, FIG. 1 illustrates a cybersecurity decoy system intended for integration into an industrial control network. The system is designed to emulate various industrial devices and to protect the network from potential cyber threats by presenting a realistic and sophisticated decoy.

The system includes a DIN-rail compatible enclosure 100. Within the housing 100 is a central I/O unit, referred to as the physical simulated analog/discrete I/O with embedded signal generator 112. This component is responsible for handling input/output (I/O) signals from simulated devices and generating realistic analog and discrete signals that mimic those of real industrial devices.

Generated by the I/O unit 112 are several example simulated devices that replicate the behavior of real industrial equipment. These simulated devices include a simulated motor 102 that operates in a discrete on/off state, a simulated level sensor 104 providing continuous analog signals to measure levels of liquids or materials, a simulated temperature sensor 106 that mimics temperature monitoring, a simulated flow meter 108 replicating the measurement of flow rates, and a simulated pump 110 functioning similarly to the motor 102 in a discrete on/off manner.

The simulated devices are managed by an embedded programmable logic controller (PLC) 114, which is also housed within the enclosure 100. The embedded PLC 114 runs control logic that mirrors real industrial processes, processing signals from the simulated devices and generating appropriate responses to enhance the realism of the decoy. Additionally, the PLC generates physical discrete outputs 115 for alarming. These outputs are triggered if the decoy device detects unauthorized activity, providing immediate notification of potential threats within the industrial environment.

The cybersecurity device further includes an embedded single-board computer (SBC) 116 within the enclosure 100. This SBC 116 acts as a Modbus client/server, SCADA client, moving target server, and virtual network TAP. It handles the network communications and simulates the protocols typically used in industrial environments, such as Modbus, Profibus, or OPC UA. The SBC 116 is connected to the broader industrial network via a device Ethernet network connection 120, allowing the decoy system to interact with the network as though it were a legitimate system.

Externally, the system includes additional components that interact with the internal components housed within the enclosure 100. A data diode 124 is connected to the device, enforcing one-way data flow from the decoy system to a remote server. This data diode 124 ensures that data can only be sent outward, preventing any potential threats from reversing the flow of information back into the actual control network.

On the remote side of the data diode 124, the system includes a second embedded single-board computer (SBC) 118, which functions as a Modbus server and threat detection server. This SBC 118 collects data on potential intrusions and monitors the network for unauthorized access. The logged data transmitted through the data diode 124 from the internal SBC 116 is processed by this external SBC 118, enabling threat analysis and further security actions.

Connected to the second SBC 118, is an embedded cellular modem 126. This modem 126 is used for remote telemetry, threat data transmission, and troubleshooting. It provides a secure, external communication path, allowing network administrators to monitor and manage the decoy system remotely.

The connections between the embedded PLC 114 and the I/O unit 112 may involve a two-way Modbus communication link, ensuring bidirectional communication within the device. This allows the PLC 114 to control the simulated devices and receive feedback, maintaining the appearance of a functioning industrial system. The embedded single-board computer 116 communicates with the PLC 114 over a similar Modbus link.

The system's architecture creates a realistic decoy system that integrates into an industrial control network and gives operators more time to identify and deal with threats. In an example implementation, the cybersecurity device might utilize a Raspberry Pi 4 as the core compute board within the embedded single-board computer 116. The Raspberry Pi 4's processing power enables it to handle real-time data processing, network traffic monitoring, and dynamic network alterations, making it well-suited for the functions described. Additional peripherals such as ADC modules might be integrated to manage analog signal inputs from the simulated sensors, and a high-precision clock could be included to maintain accurate synchronization with the industrial control network.

The software running on the process controller within the embedded PLC 114 and the SBC 116 initializes and manages the hardware components, ensuring interaction between the simulated devices and the network. This software includes modules for dynamic network configuration, allowing the system to periodically alter its MAC address, IP address, and open ports to present a moving target to potential intruders. Furthermore, the system's emulation engine utilizes a database of known parameters for devices from manufacturers such as Rockwell Automation, Siemens, and Schneider Electric, enabling it to accurately replicate the behavior of these devices.

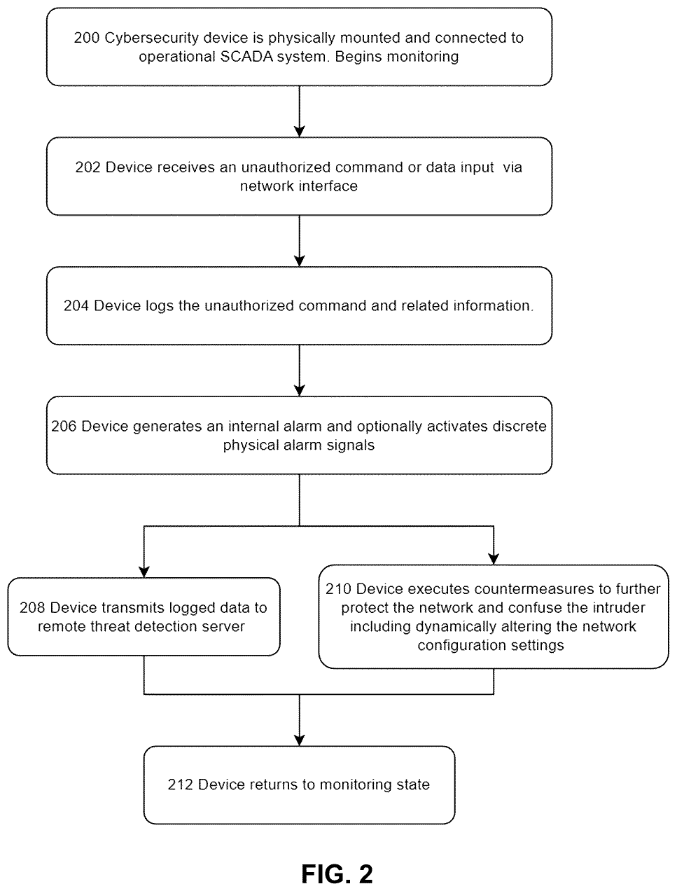

FIG. 2 illustrates a computer-implemented method executed by the cybersecurity decoy system described in FIG. 1, within an example scenario where a hacker infiltrates the SCADA control system to which the device is mounted and attempts to change one or more parameters of the emulated devices.

The method begins at step 200, where the cybersecurity device is integrated into an operational SCADA system within an industrial control network. The device, already configured with its simulated sensors, actuators, and other emulated devices, is actively communicating with the SCADA system as a legitimate part of the network. However, as the device is designed to function as a honeypot, it is not expected to receive legitimate commands or inputs from the SCADA system or other authorized network components.

In step 202, the device receives an unexpected command or data input. Because the device is a honeypot, any such command or input is automatically assumed to be unauthorized and likely originating from a malicious actor who has gained access to the network. The command might involve altering the operational parameters of one or more of the emulated devices, such as changing the setpoint of a simulated temperature sensor, modifying the flow rate of a simulated flow meter, or toggling the state of a simulated motor or pump.

Step 204 involves the immediate logging of the unauthorized command by the device. The log includes detailed information about the command, such as the source and destination IP addresses, the specific command issued, the time of the event, and any changes made to the device parameters. This logging is for creating a record of the intrusion, which can be used later for forensic analysis or to refine the security measures of the network.

In response to the detected unauthorized interaction, step 206 is triggered, where the cybersecurity device's process controller, which is part of the embedded programmable logic controller (PLC), generates an internal alarm. This alarm may be communicated directly to the SCADA system via Modbus or another relevant industrial protocol, indicating that an unauthorized change has been detected. The process controller may also activate physical discrete outputs that trigger visual or audible alarms within the physical environment, alerting personnel to the breach.

In step 208, the cybersecurity device transmits the logged data to a remote threat detection server via a secure, unidirectional data transmission channel enforced by a data diode. The data sent includes all relevant details of the unauthorized command, allowing the remote server to perform further analysis, correlate the event with other network activities, and take appropriate countermeasures if necessary.

Simultaneously, in step 210, the cybersecurity device executes a set of countermeasures designed to further protect the network and confuse the intruder. These may include dynamically altering the network configuration settings of the device, such as changing its MAC address, IP address, or open ports, to present a moving target that is harder for the attacker to exploit. The device may also simulate device failures or unusual behavior in response to the unauthorized command, making it more difficult for the intruder to achieve their intended goals.

The method concludes with step 212, where the cybersecurity device returns to a monitoring state, continuing to emulate industrial devices and communicate with the SCADA system while remaining vigilant for further unauthorized activities.

The system's ability to detect, log, and respond to intrusions ensures that any potential threats are swiftly addressed, minimizing the risk to the actual industrial control network.

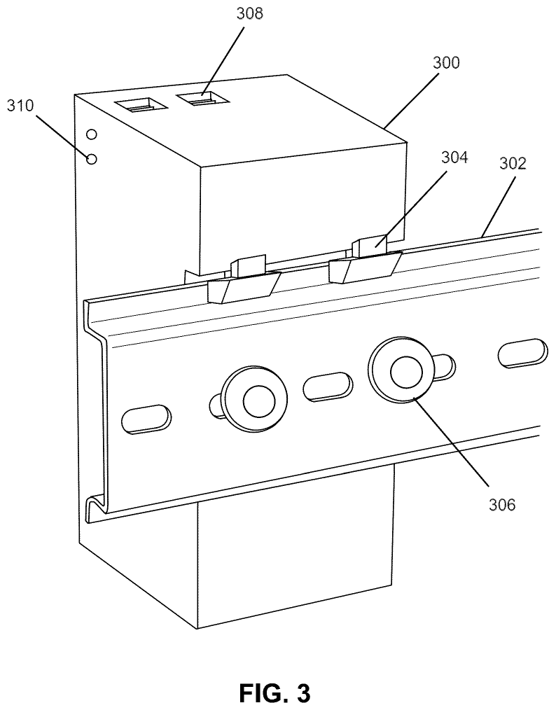

FIG. 3 illustrates a simple isometric perspective view of the cybersecurity device housing 300 mounted to a DIN rail 302 within an industrial control environment.

The housing 300 is depicted as a rectangular enclosure that meets the standard dimensions for DIN rail mounting, ensuring compatibility with a wide range of industrial settings. The housing 300 is constructed from durable materials, such as high-impact plastic or metal, designed to withstand harsh industrial conditions, including exposure to dust, moisture, and vibration.

The device is securely attached to the DIN rail 302 using a dual fastening mechanism. First, the housing 300 features standard DIN rail clips 304 integrated into the back or underside of the housing 300. These clips 304 allow for quick and easy attachment to the DIN rail 302, facilitating rapid installation or removal without the need for specialized tools. In addition to the clips 304, the housing 300 is further secured to the DIN rail 302 using a screw and washer coupling 306 that passes through the holes running along the center of the DIN rail 302. This screw and washer coupling 306 ensures that the device remains firmly in place. In practice, either, both or alternative coupling means can be used.

On the exterior of the housing 300, the only visible ports are Ethernet connection ports 308, located on one side of the enclosure. These Ethernet ports 308 are configured to connect the cybersecurity device to the broader industrial network, enabling communication with other networked components and allowing the device to perform its functions as part of the SCADA system.

The housing 300 may also include one or more status indicators 310, such as LEDs, positioned on the front or top face of the enclosure. These indicators 310 provide visual feedback on the operational status of the device, such as power, network activity, or alarm conditions, allowing onsite personnel to quickly assess the status of the device at a glance.

### Controller/Processor Components

A controller or processor as described herein can be any suitable type of computer. A computer may be a uniprocessor or multiprocessor machine. Accordingly, a computer may include one or more processors and, thus, the aforementioned computer system may also include one or more processors. Examples of processors include sequential state machines, microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), gated logic, programmable control boards (PCBs), and other suitable hardware configured to perform the various functionality described throughout this disclosure.

The computer may advantageously be equipped with a network communication device such as a network interface card, a modem, or other network connection device suitable for connecting to one or more networks.

A computer may advantageously contain control logic, or program logic, or other substrate configuration representing data and instructions, which cause the computer to operate in a specific and predefined manner as, described herein. In particular, the computer programs, when executed, enable a control processor to perform and/or cause the performance of features of the present disclosure. The control logic may advantageously be implemented as one or more modules. The modules may advantageously be configured to reside on the computer memory and execute on the one or more processors. The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro code, circuitry, data, and/or the like.

The control logic conventionally includes the manipulation of digital bits by the processor and the maintenance of these bits within memory storage devices resident in one or more of the memory storage devices. Such memory storage devices may impose a physical organization upon the collection of stored data bits, which are generally stored by specific electrical or magnetic storage cells.

The control logic generally performs a sequence of computer-executed steps. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, files, or the like. It should be kept in mind, however, that these and some other terms should be associated with appropriate physical quantities for computer operations, and that these terms are merely conventional labels applied to physical quantities that exist within and during operation of the computer based on designed relationships between these physical quantities and the symbolic values they represent.

It should be understood that manipulations within the computer are often referred to in terms of adding, comparing, moving, searching, or the like, which are often associated with manual operations performed by a human operator. It is to be understood that no involvement of the human operator may be necessary, or even desirable. The operations described herein are machine operations performed in conjunction with the human operator or user that interacts with the computer or computers.

It should also be understood that the programs, modules, processes, methods, and the like, described herein are but an exemplary implementation and are not related, or limited, to any particular computer, apparatus, or computer language. Rather, various types of general-purpose computing machines or devices may be used with programs constructed in accordance with some of the teachings described herein. In some embodiments, very specific computing machines, with specific functionality, may be required.

### CONCLUSION

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the cybersecurity device of the invention have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A cybersecurity device for integration into a networked system, comprising:
a physical housing configured for attachment to a mounting structure;
one or more processors disposed within the housing;
a plurality of input/output (I/O) interfaces disposed within or on an exterior of the housing, wherein the I/O interfaces are configured to receive and transmit signals;
a network interface disposed within the housing, the network interface configured to connect the cybersecurity device to a network;
a memory disposed within the housing, the memory storing executable instructions that, when executed by the one or more processors, cause the one or more processors to:
emulate a plurality of devices, each emulated device replicating known parameters associated with a corresponding real device;
alter network configuration settings of the cybersecurity device, the network configuration settings comprising at least one of a Media Access Control (MAC) address, an Internet Protocol (IP) address, and open network ports
present the emulated devices to a system as real devices by communicating with the system using a communication protocol;
monitor network traffic received via the network interface for identifying and recording network communications directed towards the emulated devices;
log data related to the network communications and detected changes in the emulated devices in response to the network communications; and
transmit the logged data to an external server via a unidirectional data transmission channel.

2. The cybersecurity device of claim 1, wherein the mounting structure comprises a DIN rail.

3. The cybersecurity device of claim 1, wherein the plurality of emulated devices comprises industrial control devices selected from the group consisting of sensors, actuators, and programmable logic controllers.

4. The cybersecurity device of claim 3, wherein the industrial control devices are emulated based on known parameters of devices manufactured by Rockwell Automation, Siemens, or Schneider Electric.

5. The cybersecurity device of claim 1, wherein the I/O interfaces are configured to receive and transmit analog signals.

6. The cybersecurity device of claim 1, wherein the I/O interfaces are configured to receive and transmit discrete signals.

7. The cybersecurity device of claim 1, wherein the memory stores a database of known parameters for emulating the plurality of devices, the database being accessible by the one or more processors during the emulation process.

8. The cybersecurity device of claim 1, wherein the alteration of network configuration settings is performed dynamically based on predefined time intervals or in response to detected network conditions.

9. The cybersecurity device of claim 1, wherein the one or more processors are further configured to scan the network to identify available network configuration settings, the scanning being performed prior to altering the network configuration settings.

10. The cybersecurity device of claim 1, wherein the network interface is further configured to create multiple virtual network interfaces, each having distinct network configuration settings.

11. The cybersecurity device of claim 10, wherein the multiple virtual network interfaces are configured to simulate the presence of multiple devices on the network.

12. The cybersecurity device of claim 1, wherein the logged data related to the network communications includes at least one of the following: source and destination addresses, communication timestamps, communication protocols used, and the content of the communications.

13. The cybersecurity device of claim 1, wherein the external server to which the logged data is transmitted is configured to perform threat analysis based on the logged data.

14. The cybersecurity device of claim 1, wherein the unidirectional data transmission channel comprises a data diode.

15. The cybersecurity device of claim 1, wherein the housing comprises environmental protection features, including at least one of the following: dust resistance, water resistance, and vibration damping.

16. The cybersecurity device of claim 1, wherein the one or more processors are further configured to execute self-diagnostic routines to monitor the operational status of the cybersecurity device.

17. The cybersecurity device of claim 16, wherein the self-diagnostic routines include monitoring for hardware faults, power supply stability, and environmental conditions.

18. The cybersecurity device of claim 1, wherein the cybersecurity device is further configured to generate physical alarm outputs via the I/O interfaces in response to detected network threats or anomalies.

19. The cybersecurity device of claim 1, wherein the housing includes indicators, selected from the group consisting of LEDs, that provide visual feedback on the operational status of the cybersecurity device.
